(19) United States
(12) Patent Application Publication
(10) Pub. No.: US 2016/0200127 A1
(43) Pub. Date: Jul. 14, 2016

(54) IMPRINTING APPARATUS AND METHOD FOR OPERATING IMPRINTING APPARATUS

(71) Applicant: Samsung Display Co., Ltd., Yongin-city (KR)

(72) Inventors: Tae Gyun KIM, Seoul (KR); Jin Lak Kim, Osan-si (KR)

(21) Appl. No.: 14/738,082

(22) Filed: Jun. 12, 2015

(30) Foreign Application Priority Data
Jan. 8, 2015 (KR) 10-2015-0002542

(51) Int. Cl. B41K 3/54

(52) U.S. Cl. CPC B41K 3/54

(57) ABSTRACT

Provided is an imprinting apparatus including: a stamp disposed on an area of a film; a first roller and a second roller configured to rotatably support the film such that the stamp moves along a lengthwise direction of the film as the first roller and the second roller rotate; a substrate which has an area corresponding to an area of the stamp and including a resin-coated surface disposed on a surface of the substrate; and a transfer unit which transfers the substrate while maintaining the resin-coated surface of the substrate faces downward.

### CROSS-REFERENCE TO RELATED APPLICATION

This application claims priority from and the benefit of Korean Patent Application No. 10-2015-0002542, filed on Jan. 8, 2015, which is hereby incorporated by reference for all purposes as if fully set forth herein.

### BACKGROUND

1. Field

Exemplary embodiments relate to an imprinting apparatus and method. More particularly, exemplary embodiments relate to a large-area imprinting apparatus and method.

2. Discussion of the Background

Nanofabrication includes the fabrication of very small structures that have features on the order of 100 nanometers or smaller. One application in which nanofabrication has had a significant impact is in the processing of integrated circuits. The semiconductor processing industry continues to strive for larger production yields while increasing the circuits per unit area formed on a substrate, therefore nanofabrication has become increasingly important. Nanofabrication provides greater process control while allowing continued reduction of the minimum feature dimensions of the structures formed in a device.

In particular, fabricating nanostructures using wire grid polarizer fabrication equipment generally requires particle management for nano-patterns to reduce defective products. That is, to obtain nano-patterns without defects, a chamber type may need to be used, or particle areas need to be managed. However, since current large-sized imprinting equipment for larger displays is larger in size than conventional semiconductor equipment, it may be difficult to configure the imprinting equipment in a chamber.

If a dispenser, an inkjet head, etc. is used, it is difficult to configure a vacuum chamber. Further, particles of the current equipment are generated mostly by a driver and need to be cleaned continuously.

In addition, particles are generated while the dispenser, the inkjet head, and a film are being moved. Thus, there is a need to keep an imprinting mold clean when the imprinting mold is reused.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide an imprinting apparatus configured to keep a pattern surface of a substrate clean. A resin-coated surface of a substrate faces downward and presses against a stamp having a nano-printing pattern disposed beneath the resin-coated surface of the substrate.

Additional aspects will be set forth in the detailed description which follows, and, in part, will be apparent from the disclosure, or may be learned by practice of the inventive concept.

An exemplary embodiment discloses an imprinting apparatus including: a stamp disposed on an area of a film; a first roller and a second roller configured to rotatably support the film such that the stamp moves along a lengthwise direction of the film as the first roller and the second roller rotate; a substrate which has an area corresponding to an area of the stamp and including a resin-coated surface disposed on a surface of the substrate; and a transfer unit which transfers the substrate while maintaining the resin-coated surface of the substrate faces downward.

An exemplary embodiment also discloses an imprinting method including: forming a resin-coated surface by coating resin on a bottom surface a substrate; placing the resin-coated surface to face downward toward a ground and fixing a top surface to a transfer unit by to suction; forming a stamp on a film using a master mold; and pressing the resin-coated surface of the substrate against the stamp by moving the resin-coated surface downward toward the stamp.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a schematic diagram illustrating a configuration of an imprinting apparatus according to an exemplary embodiment.

FIG. 2 is a schematic diagram of an injector and an ink cartridge applied in the imprinting apparatus of FIG. 1 according to an exemplary embodiment.

FIG. 3 illustrates a state where a transfer unit applied in the imprinting apparatus of FIG. 1 has moved to a stamp of a film according to an exemplary embodiment.

FIG. 4 illustrates a state where a resin-coated surface of a substrate applied in the imprinting apparatus of FIG. 1 has been pressed against a stamp of a film according to an exemplary embodiment.

FIG. 5 illustrates a state where the resin-coated surface of the substrate applied in the imprinting apparatus of FIG. 1 has been patterned according to an exemplary embodiment.

FIG. 6 is a schematic diagram illustrating a configuration of an imprinting apparatus according to an exemplary embodiment.

FIG. 7 illustrates a state where a transfer unit applied in the imprinting apparatus of FIG. 6 has moved to a stamp of a film according to an exemplary embodiment.

FIG. 8 illustrates a state where a resin-coated surface of a substrate applied in the imprinting apparatus of FIG. 6 has been pressed against the stamp of the film according to an exemplary embodiment.

FIG. 9 illustrates a state where the resin-coated surface of the substrate applied in the imprinting apparatus of FIG. 6 has been patterned according to an exemplary embodiment.

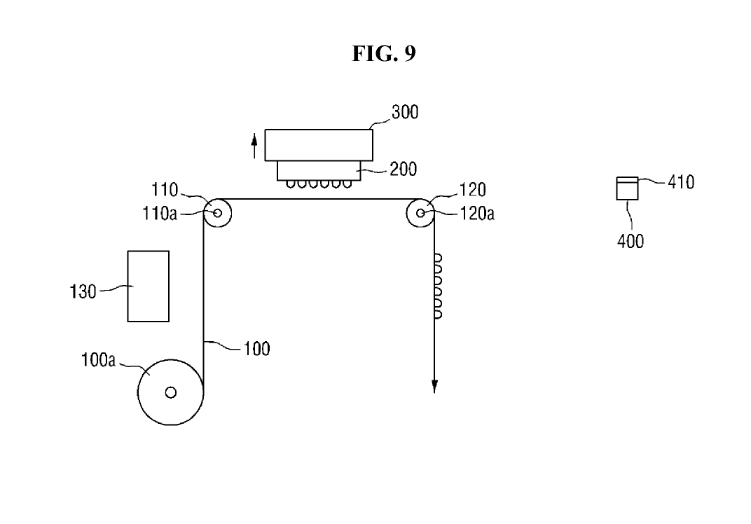

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

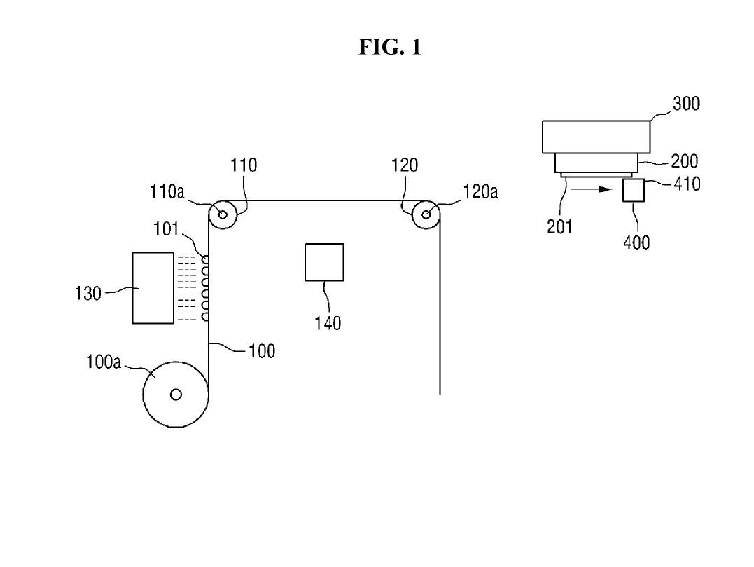

FIG. 1 is a schematic diagram illustrating a configuration of an imprinting apparatus according to an exemplary embodiment. Referring to FIG. 1, the imprinting apparatus includes stamps 101, first roller 110 and second roller 120, substrate 200, and transfer unit 300. Stamps 101 are formed on an area of film 100 having a predetermined width and length. First roller 110 and second roller 120 rotatably support the film 100 on both sides along a lengthwise direction of film 100 such that stamps 101 can be moved along the lengthwise direction of film 100. Substrate 200 has an area corresponding to the area of each of stamps 101, and resin-coated surface 201 is formed on substrate 200. Transfer unit 300 transfers substrate 200 by fixing substrate 200 thereto such that resin-coated surface 201 of substrate 200 faces the ground (“facing downward”).

Film 100 including stamps 101 may be a flexible material such as polyethylene terephthalate (PET). PET is a synthetic resin that is flexible and transparent. It has appropriate characteristics as a soft mold on which a fine pattern may be formed. More specifically, PET may be a soft mold onto which a pattern of a master mold can be pressed and transferred. Resin described in one or more exemplary embodiments may include acrylic ultraviolet (UV)-curable resin that is transparent and has excellent molding processability and UV curability.

Winding roller 100a is a roller around which film 100 imprinted with the pattern of the master mold has been wound. While elements related to the winding roller 100a are not illustrated in more detail in the drawing, an exemplary embodiment of a process of manufacturing the winding roller 100a is as follows.

First, an unwinding roller, around which a synthetic resin film has been wound, is prepared and rotatably installed in proximity to a resin coating device. The film unwound from the unwinding roller is moved on a resin coating roller by a transfer roller. The resin coating roller rotates while being partially immersed in a container that contains UV-curable resin. As the resin coating roller rotates, it coats the UV-curable resin on a surface of the film to a predetermined thickness. The film coated with the UV-curable resin is transferred to a pattern forming device by the transfer roller.

The pattern forming device may include a master mold having a fine pattern provided on an outer circumferential surface of a roller and a press roller which presses a film coated with UV-curable resin against the master mold as the film passes between the master mold and the press roller.

The pattern of the master mold (not shown), made of a metal material, is imprinted at regular intervals on an area of film 100 in which resin is coated along the lengthwise direction of film 100 disposed on an outer circumferential surface of the press roller. That is, if the master mold is pressed against film 100 coated with resin, the pattern of the master mold is transferred to the resin.

Then, the resin is cured by radiating UV light onto the resin. After the resin is cured, the cured resin of the film 100 is separated from the master mold, thereby producing stamp 101 made of a flexible material. That is, stamps 101 may be formed on film 100 along the lengthwise direction of film 100.

The pattern of the master mold may be a fine pattern including parallel stripes for manufacturing a wire grid polarizer. More specifically, since the master mold (not shown) is pressed against the resin coated on film 100, each stamp 101 has a pattern including opposite protrusions and recesses to those of the pattern of the master mold. A fine pattern of parallel stripes may be formed on a surface of each stamp 101. More specifically, each stamp 101 may have a pattern of protrusions and recesses separated from each other and having a predetermined length. However, various patterns other than the above pattern are also applicable.

Each stamp 101 of film 100 may be moved by rotation of first roller 110 and second roller 120. In an exemplary embodiment, film 100 is rotatably supported by first roller 110 and second roller 120. However, film 100 may be coupled to or supported by one or more rollers. That is, one or more rollers may further be provided between the first roller 110 and the second roller 120 to rotatably support film 100, together with first roller 110 and second roller 120.

First roller 110 and second roller 120 are rotated in the same direction with a predetermined distance therebetween along the lengthwise direction of film 100. Therefore, as film 100 unwinds from winding roller 100a, the stamps 101 on the film 100 are moved.

The rotation of first roller 110 and second roller 120 may be instantaneously stopped when a stamp 101 is positioned at a location corresponding to a cleaning direction of a cleaning device 130, when the stamp 101 is located in a horizontal field, and when the stamp 101 is located in a vertical field toward a discharge part, which will be described later in more detail.

Resin-coated surface 201 may be formed on a surface of substrate 200. Resin-coated surface 201 may be formed by injector 400. Substrate 200 may be transferred by transfer unit 300, e.g., a chuck. In particular, an opposite surface of the substrate 200 from the resin-coated surface 201 is sucked onto transfer unit 300 in a state where the resin-coated surface 201 of substrate 200 is placed to face the ground (“facing downward”). Transfer unit 300 may be configured as pneumatic, vacuum, pin-type, groove-type, electrostatic, electromagnetic, and/or other similar chuck types. However, any unit that can suck or absorb the substrate 200 may be applicable as the transfer unit 300. In addition, the transfer unit 300 may be automated using a semiconductor loader. Since the resin-coated surface 201 of the substrate 200 is placed to face the ground by the transfer unit 300, particles and other foreign matter generated by the friction of each of a driver (not shown) for moving the transfer unit 300, the first roller 110, and the second roller 120 against the film 100 can be prevented from accumulating on the resin-coated surface 201.

In addition, transfer unit 300 can change a vertical distance from the stamps 101 disposed on the film 100 along the lengthwise direction of film 100. Transfer unit 300 having the surface of the substrate 200 sucked thereto can move not only in a horizontal direction with respect to the ground but also in a vertical direction with respect to the ground.

In a state where a stamp 101 is stopped at a location vertically overlapped by transfer unit 300, the transfer unit 300 may move downward to contact the stamp 101 on film 100 and press stamp 101.

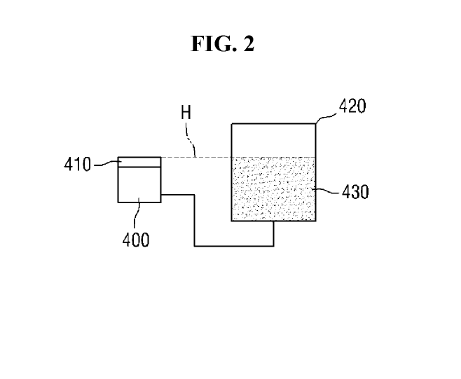

FIG. 2 is a schematic diagram of injector 400 and ink cartridge 420 applied in the imprinting apparatus of FIG. 1, according to an exemplary embodiment. Referring to FIG. 2 together with FIG. 1, injector 400 coats resin, on substrate 200 turned upside down, by spraying the resin upward toward the bottom surface of substrate 200 that faces injector 400. Injector 400 may include nozzle surface 410 from which ink is sprayed. The speed at which ink is sprayed from nozzle surface 410 of injector 400 may be 7 to 10 m/s to have a sufficient inertial force to dispose the resin on the bottom surface of substrate 200. Even if injector 400 is turned upside down, it can still spray ink based on the configuration of injector 400 and ink cartridge 420, and a distance between injector 400 and substrate 200 may be maintained at up to approximately 1 mm. In particular, for inkjet printing involving upward spraying toward the bottom surface of substrate 200, nozzle surface 410 and the surface level of ink 430 contained in ink cartridge 420 may be maintained at the same height H. Nozzle surface 410 and the upper surface level of ink 430 may be maintained at the same height to maintain the pressure head.

Stamps 101 on film 100 may be rotated in the same direction as the rotation direction of first roller 110 and second roller 120 while being moved along the lengthwise direction of film 100. First roller 110 and second roller 120 may be rotated by respective spindles 110a and 120a. Spindle 110a of first roller 110 and spindle 120a of second roller 120 may be located at the same height and separated from each other by a predetermined distance.

In the exemplary embodiment, first roller 110 and second roller 120 are located at the same height. However, as long as a driving force that moves stamps 101 of film 100 during an imprinting process can be secured according to a condition surrounding environment, spindle 110a of first roller 110 and spindle 120a of second roller 120 may be located at different heights such that film 100 is slanted with respect to the ground. The angle between the ground surface and the surface of the film may be determined based on different design considerations.

An area between first roller 110 and second roller 120 in which film 100 is parallel to the ground may be defined as a horizontal field. When stamp 101 is located in the horizontal field, an imprinting process which will be described later is performed. An area outside the area between first roller 110 and second roller 120 may be defined as a vertical field in which film 100 moves downward toward the ground or moves upward.

The vertical field is disposed on both sides of the horizontal field along a lengthwise direction of the horizontal field. Winding roller 100a around which film 100 has been wound may be located in any one of the vertical fields disposed on both sides of the horizontal field, and another winding roller (not shown) for reusing stamps 101 may be located at the other vertical field. The degree of damage to each stamp 101 of film 100 may be inspected. If it is determined in the inspection process that stamp 101 cannot be reused, stamp 101 may be discharged to the discharge part for cutting and discarding stamp 101.

When stamp 101 of film 100 is located in the vertical field before passing through the horizontal field, cleaning device 130 may be placed to face stamp 101 from the side. Cleaning device 130 may be of a dry type, in particular, of a CO₂ gas cluster type or a cryogenic aerosol stream type, but aspects are not limited thereto. If cleaning device 130 is of the CO₂ gas cluster type, conditions may be set according to an object to be cleaned by adjusting, e.g., pressure and particle size of CO₂ cluster. In addition, if cleaning device 130 is of the cryogenic aerosol stream type, particles of 0.1 μm or less can be removed. In particular, the cleaning process by cleaning device 130 is performed in a state where a pattern surface of stamp 101 is placed to face laterally in the vertical field. Therefore, foreign matter generated by friction between film 100 and each of first roller 110 and second roller 120 can be effectively prevented from accumulating on the pattern surface of stamp 101.

Irradiating device 140 is provided to radiate UV light in a state where stamp 101 of film 100 is pressed against resin-coated surface 201 of substrate 200 in the horizontal field. An energy source (e.g., a UV source) is located between first roller 110 and second roller 140 and adjacent to resin-coated surface 201 of substrate 200 to face resin-coated surface 201 of substrate 200. When stamp 101 of film 100 is located in the horizontal field, the energy source provides curing energy for solidifying a polymerizable material of the resin-coated surface 201 of substrate 200.

The curing energy generates, e.g., UV light that causes the resin-coated surface 201 to solidify in a state where the stamp 101 is pressed against the resin-coated surface 201 of the substrate 200. As a result, a patterned layer is formed on the resin-coated surface 201. The patterned layer may have an uneven shape, such as protrusions and recesses.

The motions of transfer unit 300, first roller 110, and second roller 120 may be passively controlled by a mechanical set-up or actively controlled by cross-connected controllers. In particular, a mechanical set-up to maintain the motions of transfer unit 300, first roller 110, and second roller 120 may be based on linkage-based mechanisms, roller-to-roller in contact mechanisms, or other mechanisms.

Irradiating device 140 is driven for a period of time during which resin-coated surface 201 of substrate 200 is in contact with stamp 101 after reaching the location of irradiating device 140 in the horizontal field. This UV curing system may be an array of light-emitting diode (LED)-based UV sources, a line-type UV probe attached to a traditional Hg—Xe UV source, or the like. The distance from the UV energy source to resin-coated surface 201 of substrate 200 may be less than a few millimeters. In order to increase the UV uniformity, a thin diffusion film (not shown) may be positioned between irradiating device 140 and resin-coated surface 201 of substrate 200. When the working distance of the UV curing is less than a few millimeters, such as 5 mm, intensity can be maintained high enough to complete UV curing of the imprinting resin in less than 1 second, 0.5 second, or even 0.1 second.

An imprinting method according to an exemplary embodiment will now be described with reference to the attached drawings.

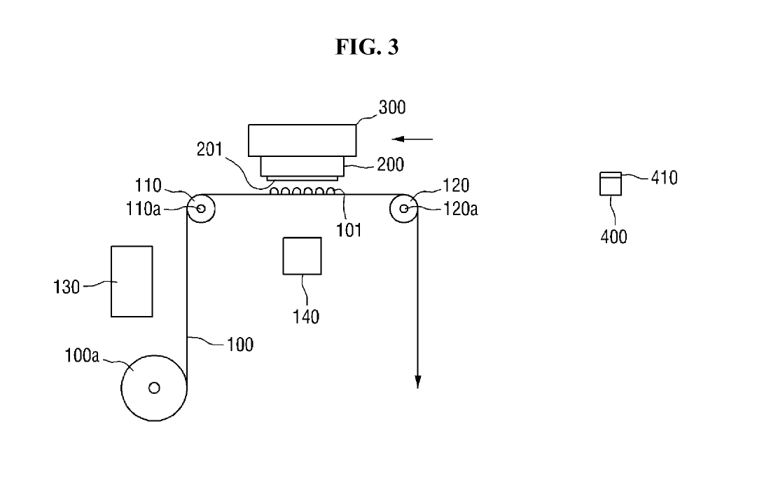

FIG. 3 illustrates a state where a transfer unit applied in the imprinting apparatus of FIG. 1 has moved to a stamp of a film according to an exemplary embodiment. Referring to FIG. 3 together with FIG. 1, after resin-coated surface 201 is formed on a surface of substrate 200 by injector 400, in a state where the surface of substrate 200 is placed to face the ground, resin-coated surface 201 of substrate 200 is moved to the horizontal field by transfer unit 300. Here, while resin-coated surface 201 is formed by injector 400, another stamp (not shown) of film 100 is positioned in the vertical field. In the vertical field, foreign matter existing on the pattern surface of another stamp is removed by cleaning device 130.

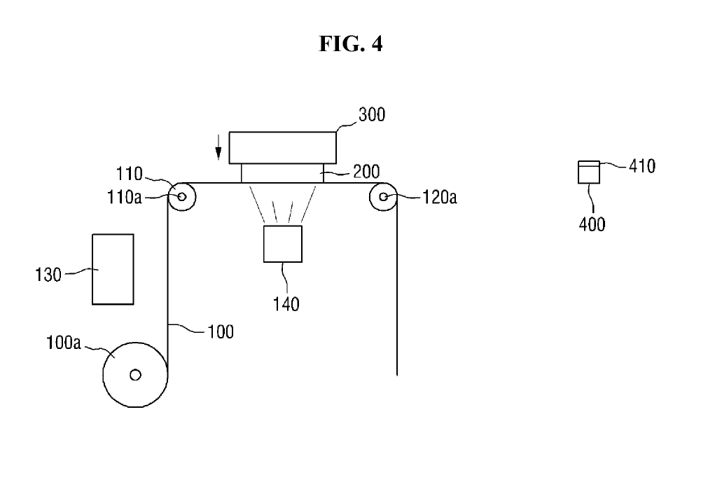

FIG. 4 illustrates a state where a resin-coated surface of a substrate applied in the imprinting apparatus of FIG. 1 has been pressed against a stamp of a film according to an exemplary embodiment. Referring to FIG. 4, at a location at which transfer unit 300, substrate 200, and stamp 101 overlap with each other, transfer unit 300 moves downward toward film 100 in a state where the rotation of first roller 110 and second roller 120 is stopped. Resin-coated surface 201 of substrate 200 is pressed against stamp 101 on film 100. Then, irradiating device 140 radiates UV light, thereby photocuring resin-coated surface 201 of substrate 200. Here, a pattern having opposite protrusions and recesses to those of the pattern of stamp 101 is formed on resin-coated surface 201.

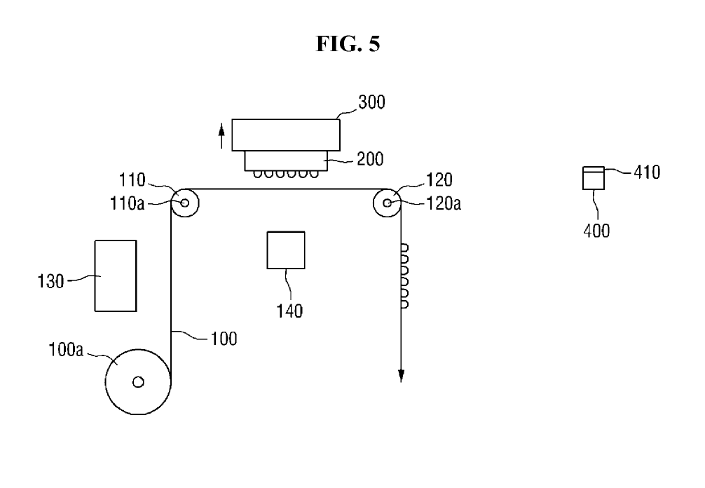

FIG. 5 illustrates a state where the resin-coated surface of the substrate applied in the imprinting apparatus of FIG. 1 has been patterned, according to an exemplary embodiment. Referring to FIG. 5, resin-coated surface 201 of substrate 200 is photocured by UV light radiated from irradiation device 140. As transfer unit 300 moves upward, patterned resin-coated surface 201 of substrate 200 is separated from stamp 101. Then, stamp 101 is moved to the vertical field on the opposite side from cleaning apparatus 130 by the rotation of first roller 110 and second roller 120. Although not illustrated in the above, after stamp 101 passes through the horizontal field upon completing patterning, another stamp 101 may be repeatedly unwound from winding roller 100a.

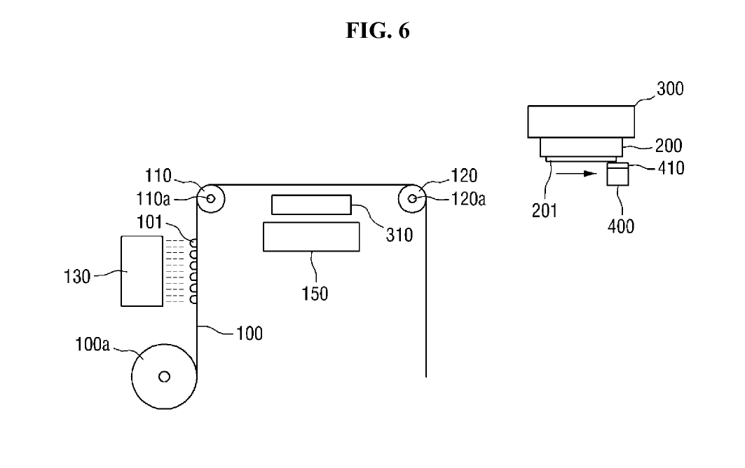

FIG. 6 is a schematic diagram illustrating a configuration of an imprinting apparatus, according to an exemplary embodiment. Referring to FIG. 6, the imprinting apparatus includes stamps 101, first roller 110, second roller 120, substrate 200, transfer unit 300, and support chuck 310. Each of stamps 101 may be formed on an area of film 100 having a predetermined width and length. First roller 110 and second roller 120 rotatably support film 100 on both sides along a lengthwise direction of film 100 such that stamps 101 can be moved along the lengthwise direction of film 100. Substrate 200 has an area corresponding to the area of each of stamps 101, and resin-coated surface 201 is formed on substrate 200. Transfer unit 300 transfers substrate 200 after fixing substrate 200 thereto by e.g., suction such that resin-coated surface 201 of substrate 200 faces the ground. Support chuck 310 supports resin-coated surface 201 of substrate 200 in an opposite direction to a direction in which resin-coated surface 210 of substrate 200 moves downward when transfer unit 300 moves downward toward stamp 101.

The imprinting apparatus of FIG. 6 may be identical to the imprinting apparatus of FIG. 1 except that the imprinting apparatus of FIG. 6 further includes support chuck 310.

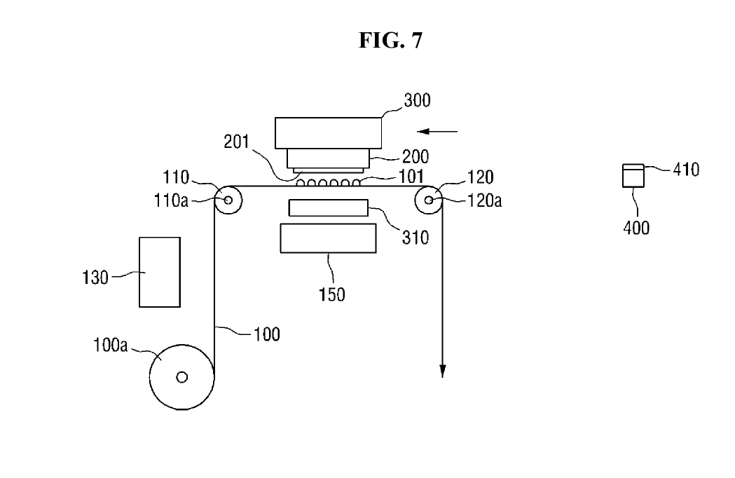

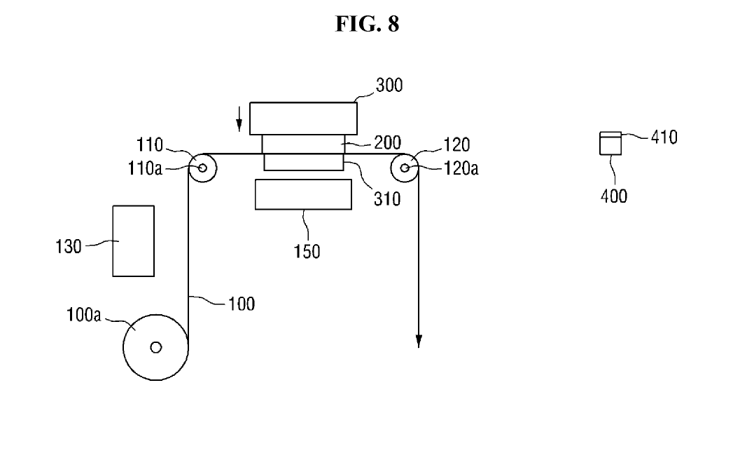

FIG. 7 illustrates a state where a transfer unit applied in the imprinting apparatus of FIG. 6 has moved to a stamp of a film according to an exemplary embodiment. FIG. 8 illustrates a state where a resin-coated surface of a substrate applied in the imprinting apparatus of FIG. 6 has been pressed against a stamp of a film according to an exemplary embodiment. Referring to FIG. 7 and FIG. 8 together, after transfer unit 300 is moved such that substrate 200 and stamp 101 overlap with each other in a vertical direction, transfer unit 300 moved downward toward film 100 in a state where the rotation of first roller 110 and second roller 120 is stopped. Accordingly, resin-coated surface 201 of substrate 200 is pressed against stamp 101 on film 100. Here, when resin-coated surface 201 of substrate 200 is pressed against stamp 101 of film 100, support chuck 310 which faces resin-coated surface 201 of substrate 200 with respect to stamp 101 of film 100 moves upward in the direction opposite to the direction in which transfer unit 300 moves downward.

More specifically, while resin-coated surface 201 of substrate 200 is moved toward stamp 101 of film 100 by the force of transfer unit 300, support chuck 310 moves toward resin-coated surface 201 from the opposite side. Support chuck 310 may generate a reaction force in a direction toward transfer unit 300, thereby preventing drooping of film 100 around stamp 101. Therefore, a more precise imprinting process may be performed.

If support chuck 310 includes an opaque material, UV light cannot pass through support chuck 310. Therefore, heating device 150 may be provided instead of irradiating device 140 illustrated in FIG. 1 through FIG. 4. In this case, in a state where substrate 200 is pressed against support chuck 310, a heat-curing process may be performed on resin-coated surface 210 using a heat source of heating device 150 as illustrated in FIG. 8.

One or more exemplary embodiments provide at least one of the following advantages.

An imprinting apparatus and method can keep an imprinting mold and a substrate clean by preventing foreign matter or particles from accumulating on the imprinting mold and the substrate.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. An imprinting apparatus comprising:
a stamp disposed on an area of a film;
a first roller and a second roller configured to rotatably support the film such that the stamp moves along a lengthwise direction of the film as the first roller and the second roller rotate;
a substrate which has an area corresponding to an area of the stamp and comprising a resin-coated surface disposed on a surface of the substrate; and
a transfer unit configured to transfer the substrate while maintaining the resin-coated surface of the substrate facing downward.

2. The imprinting apparatus of claim 1, further comprising an injector configured to spray resin toward the surface of the substrate in a state where the surface of the substrate is placed to face downward toward the injector.

3. The imprinting apparatus of claim 1, wherein the first roller and the second roller are positioned at a same height from a ground, a horizontal field in which the film is parallel to the ground is defined between the first roller and the second roller, and a vertical field in which the film is perpendicular to the ground is defined on both sides of the horizontal field between the first roller and the second roller.

4. The imprinting apparatus of claim 3, wherein a feed part connected to a winding roller is disposed in one of the vertical fields, and a discharge part to which the film is discharged is disposed in the other one of the vertical fields.

5. The imprinting apparatus of claim 3, further comprising a cleaning device configured to clean the stamp from the side when the stamp of the film is located in one of the vertical fields.

6. The imprinting apparatus of claim 5, wherein the cleaning device is of a dry type.

7. The imprinting apparatus of claim 1, wherein the stamp is formed by preparing a master mold having a nano-pattern and imprinting the nano-pattern of the master mold on a resin-coated area of the film, the master mold comprising a metal.

8. The imprinting apparatus of claim 1, further comprising a heating device disposed in the horizontal field and configured to heat the stamp and the resin-coated surface.

9. The imprinting apparatus of claim 8, further comprising a support chuck which faces the resin-coated surface of the substrate aligned with the stamp, wherein the support chuck and the resin-coated surface of the substrate are configured to be pressed against each other.

10. The imprinting apparatus of claim 4, wherein the stamp comprises stamp patterns disposed on the film of the winding roller with a determined interval therebetween along a winding direction of the winding roller.

11. The imprinting apparatus of claim 1, further comprising an irradiating device provided in the horizontal field and configured to radiate ultraviolet (UV) light toward the stamp and the resin-coated surface.

12. The imprinting apparatus of claim 1, wherein the stamp is a fine pattern comprising a plurality of stripes separated by a predetermined distance.

13. The imprinting apparatus of claim 1, wherein the transfer unit is configured as one of pneumatic, electrostatic, and electromagnetic chucks to fix the substrate thereto by suction.

14. The imprinting apparatus of claim 2, wherein the injector comprises a nozzle surface from which ink is sprayed, and an ink cartridge for supplying ink to the nozzle surface.

15. An imprinting method comprising:
forming a resin-coated surface by coating resin on a bottom surface a substrate;
placing the resin-coated surface to face downward toward a ground and fixing a top surface to a transfer unit by suction;
forming a stamp on a film using a master mold; and
pressing the resin-coated surface of the substrate against the stamp by moving the resin-coated surface downward toward the stamp.

16. The imprinting method of claim 15, wherein the stamp is transferred as rollers rotate, and wherein the film is rotatably supported by the rollers.

17. The imprinting method of claim 15, further comprising cleaning the stamp while the resin is being coated on the bottom surface of the substrate.

18. The imprinting method of claim 15, further comprising operating an injector having a nozzle surface which faces upward to spray the resin toward the bottom surface of the substrate in a state where the bottom surface of the substrate faces the ground.

19. The imprinting method of claim 18, wherein the nozzle surface is placed at a same height as an upper surface level of ink contained in an ink cartridge.

20. The imprinting method of claim 15, further comprising inspecting a degree of damage to the stamp to determine whether the stamp can be reused after a pattern of the stamp is transferred onto the resin-coated surface by pressing the resin-coated surface of the substrate against the stamp.
